(19) United States
(12) Patent Application Publication
(10) Pub. No.: US 2006/0226948 A1
(43) Pub. Date: Oct. 12, 2006

(54) Door lock with RFID key

(75) Inventors: Michael J. Wright, Santa Ana, CA (US); Charles W. Moon, Colorado Springs, CO (US); Ernst Kern Mitchell, Sterling Heights, MI (US); Tuan A. Tran, Garden Grove, CA (US); Michael L. Beigel, Encinitas, CA (US); Mike Remenih, San Fernando, CA (US); Scott M. Waldron, Newport Beach, CA (US)

Correspondence Address: CARLSON, GASKEY & OLDS, P.C., 400 WEST MAPLE ROAD, SUITE 350, BIRMINGHAM, MI, 48009, US

(73) Assignee: Computerized Security Systems

(21) Appl. No.: 11/101,863

(22) Filed: Apr. 8, 2005

(51) Int. Cl. H04Q 1/00; G05B 19/00

(52) U.S. Cl. 340/5.25; 340/5.61

(57) ABSTRACT

An electronic lock assembly is actuated by a key including a transponder. The key is received within a coil assembly of the lock assembly. The key engages a switch that powers the coil assembly. The coil assembly generates a magnetic field that energizes the transponder. The transponder transmits a signal received by a controller. The controller actuates the lock assembly responsive to the received signal to move a locking member to an unlocked position. The key may then move to unlatch a latch associated with the lock assembly. As the key provides the energy required for unlatching the latch further energization of the motor is not required. The lock assembly provides for the actuation and energization of the transponder with small amounts electrical energy such that the lock assembly may be powered by commercially available batteries for a practical operational life.

### BACKGROUND OF THE INVENTION

This invention is generally related to an electronic door lock. More particularly, this invention relates to an electronic door lock that utilizes a radio frequency identification tag to actuate and allow access to the lock.

Typically, an electronic door lock utilizes one of several varieties of credentials to allow access to the lock. The credential can commonly come in the form of a magnetic strip key card, a smart card, a proximity badge, or simply the use of a pin code. The use of magnetic strip key cards, smart cards, and proximity badges have certain disadvantages. In many applications the lock will include a card reader into which the key card or smart card is inserted. The key card and smart card will include a magnetic strip that stores a code or other access algorithm that is read by the electronic lock. If the code on the key card or the smart card matches some predefined criteria, the electronic lock will allow access and opening of the door latch. Disadvantageously, smart cards and key cards utilize a contact surface or a magnetic strip that can become damaged and unusable for a variety of reasons including exposure to magnetic fields or simply destruction caused by improper or rough handling. Further, it is also required that the key card be placed within the lock at a specific orientation.

Another type of credential is a proximity badge that includes a radio frequency identification tag. In such a system the radio frequency identification tag includes a transponder. The transponder does not require an internal power source but is instead energized by a radio frequency emitted from a transceiver adjacent the door. Typically, a door frame will include the transceiver that emits a frequency at specified intervals. When a person wearing or carrying a proximity badge enters the proximity of the door, the tag will become energized in response to receiving the radio frequency signal. The energized proximity badge will then emit a signal that includes an access code or other algorithm. The lock will then allow unlatching if the proper code or algorithm is received.

Such radio frequency systems require larger amounts of power to emit a signal that is powerful enough to properly energize the transponder within a desired area adjacent the doorway. Such power is often provided through the use of an AC current that is emitted through a transceiver antenna mounted adjacent the door. Such systems are not economically feasible or desirable in some applications such as in multi-housing or hotel/motel applications. In such application as hotel/motel and other multi-housing systems is desirable to include an electronic lock that is self-sufficient and does not require external wiring. Further, it is also desirably to develop a system that does not require extremely large amounts of power that are practical only be hard wiring to an AC power source. Disadvantageously, the power required for such a system is not compatible with current battery life to support a stand alone system.

Accordingly, it is desirable to develop an electronic lock that responses to a credential that is durable and that is self-sufficient to provide a practical service life.

### SUMMARY OF THE INVENTION

This invention is an electronic lock that utilizes a key containing a radio frequency identification tag. The key is inserted into the electronic lock and placed in close proximity to a coil that emits a magnetic field for energizing the transponder within the key.

The electronic lock includes a coil that surrounds a cavity into which the key is placed. Inserting this key into this cavity actuates a switch. The switch energizes the coil surrounding the key and generates a magnetic field. The magnetic field energizes the transponder within the key, which then sends a signal, which is received by the electronic lock. The lock includes a motor that will actuate in response to a proper identification code received by a proper key. The motor moves a locking dog to an unlocked position. Movement of the locking dog allows rotation of the key to unlock the lock.

The motor and coil assembly are provided electrical energy through the use of several common batteries. The power level utilized for the coil and the motor are such that only several such batteries are required to obtain a practical operational life.

Accordingly, the electronic latch assembly of this invention provides for the use of an electronic lock with significant power savings enabling the use of a stand alone device with commonly available batteries.

These and other features of the present invention can be best understood from the following specification and drawings, the following of which is a brief description.

### BRIEF DESCRIPTION OF THE DRAWINGS

FIG. 1 is a prospective view of the lock assembly according to this invention.

FIG. 2 is a plan view of an outer side of the lock assembly according to this invention.

FIG. 3 is an exploded view of the lock assembly according to this invention.

FIG. 4 is a cross-sectional view of the lock assembly and key according to this invention.

FIG. 5 is another cross-sectional view of the lock assembly with the key received within the lock.

FIG. 6 is a plan view of a portion of the electric lock assembly according to this invention.

### DETAILED DESCRIPTION OF THE PREFERRED EMBODIMENT

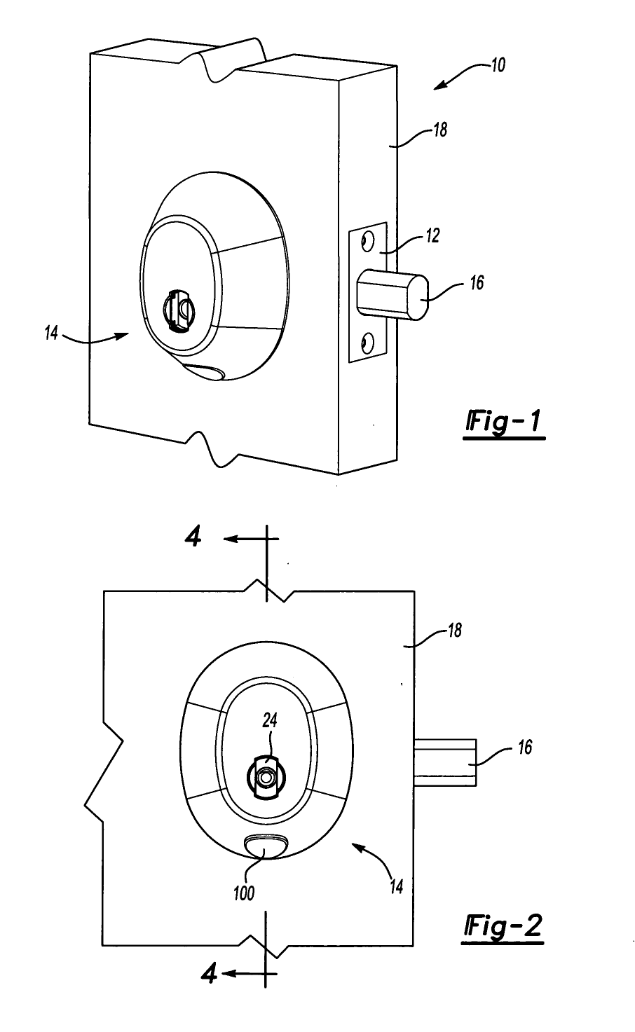

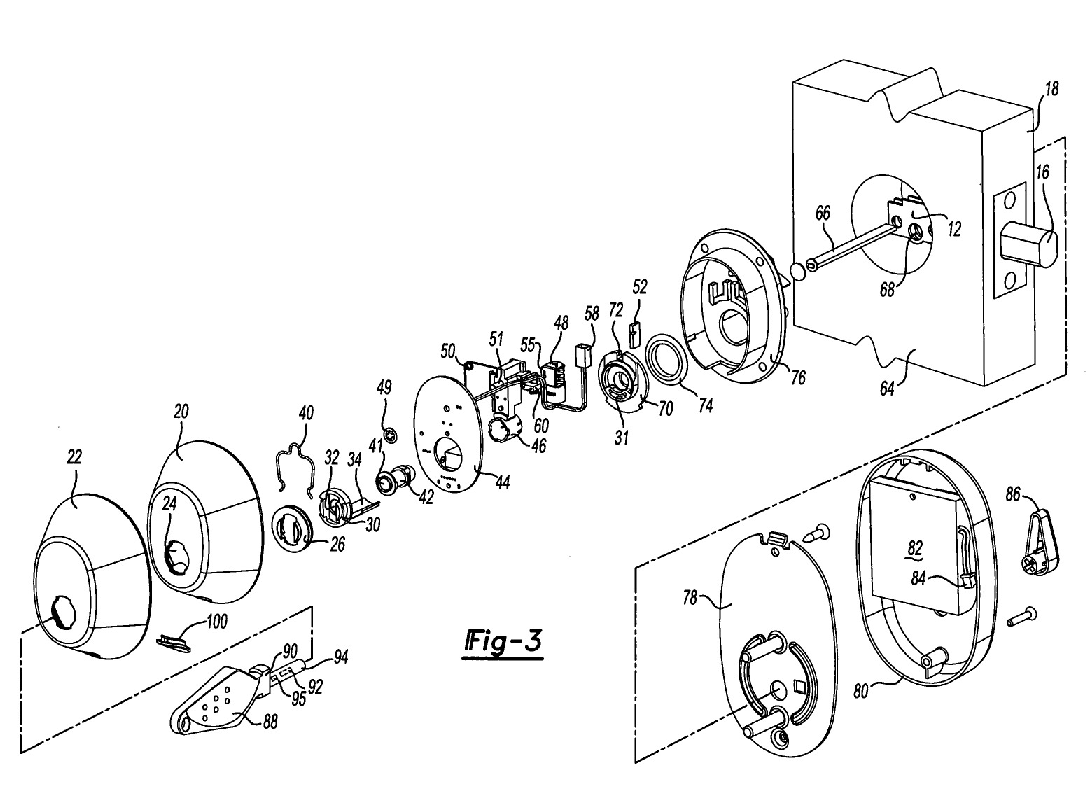

Referring to FIGS. 1 and 2, a door assembly 10 includes a latch assembly 12 with a main bolt 16. The main bolt 16 extends from the latch assembly 12 to engage a door jam (not shown) thereby preventing the door assembly 10 from being opened. A door 18 also includes an electronic lock assembly 14. The electronic lock assembly 14 corresponds and actuates the latch assembly 12 to extend and retract the main bolt 16. The electronic lock assembly 14 includes an opening 24 for a key 88 (FIG. 3) The electronic lock assembly 14 also includes a removable plug 100 that provides access to an internal electronic connection within the lock assembly 14.

Referring to FIG. 3, the lock assembly 14 is shown in an exploded view to illustrate each of the corresponding parts. The lock assembly 14 includes an outer housing 20 that covers several different internal mechanisms. The outer housing 20 is an oval shaped domed member that defines an inner chamber into which the several mechanical elements of the lock assembly 14 are installed. The outer housing 20 is typically constructed from a material that prevents damage or undesired access to the internal components of the lock assembly 14. The outer housing 20 is covered by a display cover 22. The display cover 22 is constructed of a material to provide a desired aesthetic appearance to the lock assembly 14 as it is assembled and mounted to the door 18.

The inner mechanism of the electronic lock assembly 14 includes a front bushing 26 that has a corresponding opening for the key 88. The front bushing 26 is biased towards an initial position by a biasing spring 40. This biasing spring 40 also provides feedback to a user inserting the key 88 so that the user will experience a known reaction to a key being turned within a lock.

The front bushing 26 is disposed in front of a driver 30. The driver 30 includes opening 32 that corresponds with the key 88. The key 88 is illustrated schematically and includes lugs 90. The lugs 90 correspond with the opening 32 within the front bushing 26 and the driver 30. Once the key 88 is inserted and the lugs 90 are adjacent the opening 32, the key 88 will turn and rotate the driver 30 such that a tongue portion 34 of the driver 30 will move a lock block 70. Movement of the lock block 70 will in turn move an actuation rod 66 to unlatch the latch assembly 12. The key 88 includes a barrel portion 94 that is substantially cylindrical and includes and houses the transponder 92.

Insertion of the key 88 into the lock assembly 14 places the cylindrical portion 94 within a coil assembly 42. The coil assembly 42 includes approximately 300 turns of magnetic wire powered by a power source mounted within the lock assembly 14. The coil assembly 42 generates a magnetic field in response to an applied current. The coil assembly 42 is held in place within a bobbin case 46 mounted adjacent the motor 48. The motor 48 is also powered by the onboard power source. The motor 48 is mounted to a circuit board 44 by way of a fastener 49. The fastener 49 shown is a screw that threads into a support for the motor 48.

A controller 55 receives signals from the transponder 92 in response to actuation of the coil assembly 42. The controller 55 is indicated schematically and may be of any known design. Further, a worker skilled in the art would understand how to program a commercially available controller to provide the novel functions of this invention. The controller 55 receives signals from the transponder 92 energized by the magnetic field generated by the coil assembly 42. The controller 55 compares the signal from the transponder 92 with predefined criteria and thereby selectively actuates the motor 48. The motor 48 moves a locking dog 52 upwardly. Movement of the locking dog 52 is facilitated through movement of a biasing spring 50. The motor 48 moves the biasing spring 50 upwardly. The locking dog 52 will move correspondingly upward to move free of a notch 72 within the lock block 70. The motor 48 is connected to the circuit board 44, and the circuit board 44 includes a connector 58 that connects to a power source. A switch 60 is provided that is actuated by insertion of the key 88. The switch 60 wakes up the controller from a low power sleep mode and initiates electric current to turn on the coil assembly 42.

Once the motor 48 has been actuated to move the locking dog 52 out of the notch 72, the key 88 is allowed to turn in a direction to move the actuation rod 66 to an open position that allows for unlatching of the main bolt 16.

The lock block 70 includes a slot 31 that receives the tongue 34 of the driver 32. The lock block 70 is supported within an inner housing 76. The inner housing 76 provides for the mounting of an inner plate 78 to an interior surface of the door 18. Over the inner plate 78 is inner display cover 80. The inner display cover 80 also houses a battery pack 82. The battery pack 82 includes a connector 84 that connects to the connector 58 to provide power to the controller 55 which selectively sends power to the coil assembly 42 and the motor 48. A lock lever 86 is disposed on an interior portion of the door 18 to allow unlatching of the lock assembly 14 from an interior side without the key 88.

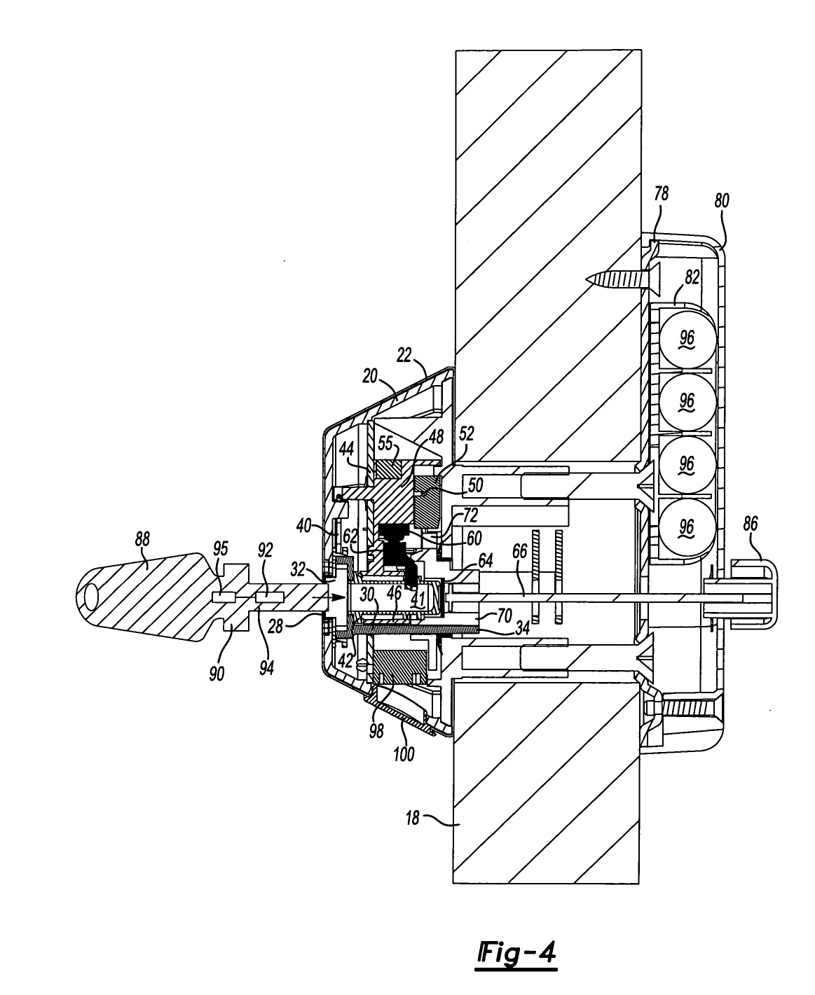

Referring to FIG. 4, the lock assembly 14 is shown in cross-section before insertion of the key 88. The lock assembly 14 is shown assembled and includes an opening 28 through both the display cover 22 and outer housing 20. The lock assembly 14 is powered by the battery pack 82 including four AA batteries 96. The four AA batteries 96 provide enough power for both the motor 48 and the coil 42 to last a desired amount of time. Typically, it is desired that the lock assembly 14 operate with the same batteries for a year or more. The power saving features of this lock assembly 14 provide that operational ability by minimizing the distance between the transponder 92 within the key 88 and by minimizing the power required to unlock the lock assembly 14.

In operation, the battery pack 82 supplies power to both the motor 48 and the coil assembly 42. However, neither are energized unless the key 88 is inserted within the lock assembly 14. The coil assembly 42 remains in an unpowered state until the key 88 is inserted therein. A switch actuator 62 extends into a cavity 41 defined within the coil assembly 42. The switch actuator 62 corresponds with the key 88 and will move upwardly to actuate the switch 60 causing energization of the coil assembly 42.

The motor 48 moves the biasing spring 50 that in turn moves the locking dog 52 between an engaged position where a portion of the locking dog 52 is disposed within the notch 72 of the lock block 70. Motor 48 moves the biasing spring 50 upward in response to receipt of a proper authorization code from the controller 55. In some instances friction caused by turning of the lock block 70 may not allow the locking dog 52 to fully extend out of the notch 72. In such instances, the motor 48 would normally require re-energization every time the locking dog 52 was desired to be moved out of the notch 72, wasting significant amounts of power. In the electronic lock assembly 14 of this invention, the locking dog 52 remains in place in some instances due to the frictional forces exerted on the locking dog 52 by the lock block 70.

However, the motor 48 moves the biasing spring 50 that provides the connection between the motor 48 and the locking dog 52 to the disengaged position. In normal operation where the locking dog 52 is free to move the spring 50 will act as a solid member and simply move the locking dog 52 free of the slot 72 to allow the lock block 70 to rotate freely. However, in instances where the locking dog 52 is not permitted to move freely, biasing spring 50 will act as a spring and still move to a position to later cause disengagement of the locking dog 52 once movement is allowed.

Because the locking dog 52 has been retained in place due to frictional engagement the spring 50 will continue to bias the locking dog 52 towards the unlocked position. Accordingly, once the locking dog 52 is free, for instance, due to the lock block 70 being rotated to a position that allows free movement, the biasing spring 50 will drive the locking dog 52 from the notch 72 without additional power from the motor 48. As appreciated, such operation provides for significant savings of electrical energy. Further, the biasing spring 50 provides a perception of more reliable operation due to the elimination of repeated unlocking attempts and repeated insertion of the key 88.

The electronic lock assembly 14 of this invention also includes an input/output port 98. The input/output port 98 provides for communication between the electronic lock assembly 14 and an external programming source. The external programming source may be plugged into and communicate with the electronic lock assembly 14 through the port 98. The port 98 is covered by the plug 100. As appreciated, a USB port or other know port configurations such as serial or other types of ports are within the contemplation of this invention. Further, it is also within the contemplation of this invention that a radio frequency transmitter may be utilized to communicate with the controller 55 of the example electronic lock assembly 14.

The lock block 70 causes rotation of the actuation rod 66. The actuation rod 66 is also engaged with the lock lever 86 on an interior portion of the door 18. Actuation rod 66 is protected by a hardened drill plug 64. The drill plug 64 prevents the use of a drill to dislodge or destroy the actuation rod 66 to gain unauthorized access to the electronic lock assembly 14.

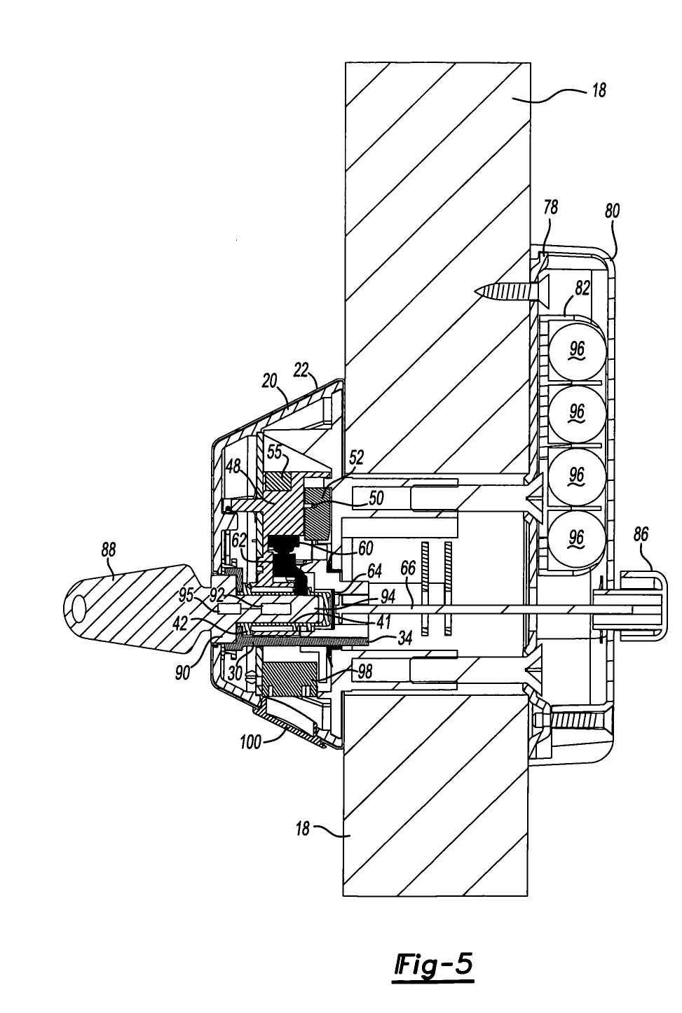

Referring to FIG. 5, the electronic lock assembly 14 is shown in cross-section with the key 88 inserted into the coil assembly 42. In this condition, the key 88 is engaged within the coil assembly 42 and has moved the switch actuator 62 to engage the switch 60. The switch 60 then releases current to the coil assembly 42. The coil assembly 42 generates a magnetic field that activates the transponder 92 within the key 88.

Because the transponder 92 is placed in such close proximity to the coil assembly 42 the magnetic field required to energize the transponder 92 is significantly reduced. Preferably, the coil assembly 42 requires only 30 milliamps of electrical energy to generate the desired magnetic field that activates the transponder 92. Although the example of 30 milliamps is discussed, it is within the contemplation of this invention that even less power may be utilized for other configurations of transponders. By inserting the key 88 into the lock assembly 14 substantially surrounded by the coil assembly 42, the level of current required to generate the magnetic field of sufficient strength to actuate the transponder is significantly reduced.

Upon actuation of the transponder 92, and if a stored value in the transponder 92 matches a stored value in the controller circuit, the motor 48 receives a signal to move the locking dog 52 to an unlocked position. The motor 48 actuates to lift the locking dog 52 from the notch 72 of the lock block 70. In the electronic lock assembly 14 of this invention the key 88 is utilized for unlatching the latch 16. The motor 48 is not utilized for this purpose. Upon release of the locking dog 52 from the notch 72 of the lock block 70 the key 88 is free to rotate. The driver 30 includes opening 32 that correspond with lugs 90 on the key 88. Rotation of the driver 30 rotates the actuation tongue 34 and thereby rotates the lock block 70.

The transponder 92 includes the stored value that includes identification information unique to a specific key 88. The value can be for example a code that corresponds to a specific lock assembly 10 that is required to allow actuation of the motor 48. The example coil 42 is also capable of writing to memory 95 present within the key 88 that corresponds with the transponder 92. Once the key 88 is accepted by the lock assembly 10, i.e. the value within the key 88 is matched with the lock assembly 10, the controller actuates the coil 42 to write information to the memory 95 within the key 88. The information stored within the key 88 can include any relevant information that is desired such as for example, a lock identification number, a room number, along with the time and date that the key 88 was used to open that lock assembly.

During operation, the key 88 identification is verified to correspond to the lock assembly and any information that is to be written to the memory 95 is accomplished prior to the controller initiating movement of the motor 48. Initiation of the motor 48 is delayed until information is written to the memory 95 to ensure that such information is written. As appreciated, once the lock assembly 10 is initiated to open, the key 88 can be removed, possibly disrupting the writing of information. Further, delaying operation of the motor 48 until information has been written to the key 88 prevents the removal of an accepted key and the use and writing to another key 88 that has not been authenticated. Therefore, writing information prior to allowing the motor 48 initiate unlocking assures that the key 88 will remain in close proximity to the coil 42 to provide for communication of information storage within the memory 95.

The management or control organization will have a key encoder station that use a coil to read and write to a specific key. Such stations are capable of generating reports that indicate key usage and which locks have been operated by which key. This capability provides a desired accountability and control over entry to specific areas, along with a comprehensive record of use for each key 88.

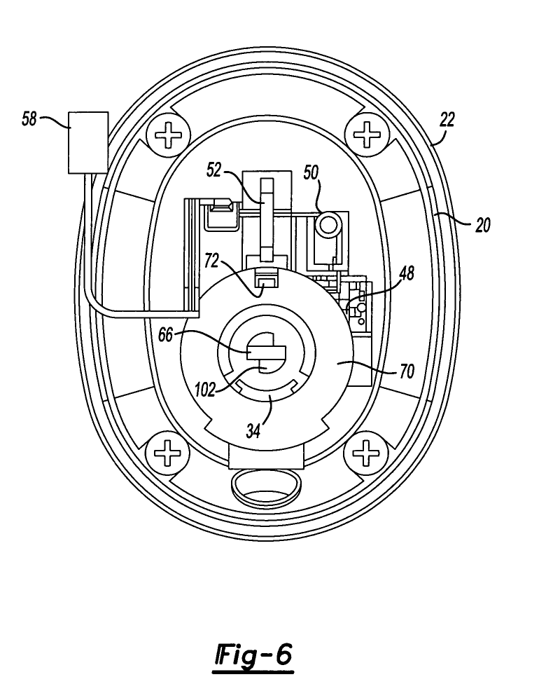

Referring to FIG. 6, a plan view of a portion of the electronic lock assembly 14 is shown at the lock block 70. The actuation tongue 34 is disposed within the slot 31 of the lock block 70. The actuation rod 66 is disposed within a butterfly opening 102 of the lock block 70. Rotation of the lock block 70 causes rotation of the actuation rod 66 that in turn provides for release and movement of the main bolt 16. In FIG. 6, the locking dog 52 can be seen removed from the notch 72 such that rotation of the lock block 70 can occur. As rotation is provided by the force required to turn the key 88 the motor 48 is no longer using any electrical power to release the lock assembly 14. This provides favorable lengthening of operational life.

Accordingly, the electronic lock assembly 14 of this invention provides for the use of the access authorization credential for a self-contained electronic lock that does not require external wiring. The key 88 of this invention includes a transponder 92 that is placed in intimate contact with the coil assembly 42 that generates the required energy to energize the transponder 19 and therefore signal the lock assembly 14 to provide access. Accordingly, the electronic lock assembly of this invention provides a self-contained lock assembly that can operate for a practical and desired time with commonly available batteries.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A door lock assembly comprising:
a drive for moving a locking member between a locked position and an unlocked position;
a magnetic field generator for selectively generating a magnetic field within said lock assembly; and
a key having a transponder insertable into said lock assembly such that said transponder is selectively actuatable responsive to exposure to said magnetic field, wherein said transponder transmits a signal initiating said drive to move said locking member toward said unlocked position.

2. The assembly as recited in claim 1 wherein said magnetic field generator comprises a coil energized responsive to insertion of said key within said lock assembly.

3. The assembly as recited in claim 2 wherein said coil surrounds a cavity receiving a portion of said key including said transponder.

4. The assembly as recited in claim 3 including a switch actuated by a switch actuator engaged when said key is at least partially received within said cavity.

5. The assembly as recited in claim 4 including a controller for initiating powering of said coil responsive to actuation of said switch.

6. The assembly as recited in claim 1 including a controller for receiving said signal emitted from said transponder and for analyzing said signal to selectively actuate said drive.

7. The assembly as recited in claim 3 wherein said cavity is cylindrical and receives a cylindrical portion of said key.

8. The assembly as recited in claim 2 wherein said coil generates a magnetic field and said transponder transmits said signal in response to exposure to said magnetic field.

9. The assembly as recited in claim 2, wherein said key includes a memory device and said coil generates a signal for writing information to said memory device.

10. The assembly as recited in claim 9, wherein said drive is not initiated until information is written to said memory device within said key.

11. The assembly as recited in claim 2, wherein said key includes a memory device that stores information relating indicative of use of said key.

12. The assembly as recited in claim 1, wherein said key includes at least one lug portion engageable for moving a portion of said lock assembly.

13. The assembly as recited in claim 12, including a lock driver selectively movable by said at least one lug portion for unlatching a latch associated with said locking assembly.

14. The assembly as recited in claim 13, wherein said drive moves said locking member to said unlocked position and said locking driver is moveable to unlatch a latch when said locking member is in said unlocked position.

15. The assembly as recited in claim 14, including an energy storage member for completing an intended motion of said locking member upon release of a temporary limit of motion.

16. The assembly as recited in claim 14, wherein said latch includes an actuating rod and said lock driver drives a lock block including a connection with said actuating rod, wherein said connection provides lost motion of a lock lever for actuating said latch without said locking member releasing the lock block.

17. The assembly as recited in claim 16, wherein said connection comprises a butterfly opening for rotating said actuating rod.

18. The assembly as recited in claim 17, wherein said butterfly opening provides for the conversion of the lock assembly between a right hand door application and left hand door application.

19. The assembly as recited in claim 1, including a power source supplying electric energy to said drive and said magnetic field generator.

20. The assembly as recited in claim 1, wherein said transponder emits a radio frequency signal responsive to exposure to said magnetic field.

21. A lock assembly comprising:
a magnetic field generator for selectively generating a magnetic field within said lock assembly for actuating a transponder insertable within said lock assembly; and
a drive for selectively moving a locking member between a locked position and an unlocked position responsive to actuation of said transponder.

22. The assembly as recited in claim 21 wherein said transponder is disposed within a key insertable into said lock assembly.

23. The assembly as recited in claim 22, wherein said drive moves said locking member and said key moves a latch to an open position.

24. The assembly as recited in claim 22, including a power source providing electrical energy to said drive and said magnetic field generator mounted within said lock assembly.

25. A method of operating a lock assembly comprising the step of;
a) generating a magnetic field with a coil responsive to receiving a transponder within the coil;
b) sending a signal from said transponder to a controller; and
c) enabling movement of a latch member responsive to said signal from said transponder.

26. The method as recited in claim 25, including evaluating said signal against a predetermined acceptance criteria and enabling movement of said latch member upon acceptance of said signal.

27. The method as recited in claim 25, wherein said step c includes moving a locking member from a locked position toward an unlocked position, and unlatching said latch member with a key.

28. The method as recited in claim 27, wherein said key includes said transponder and a memory device and including the step of writing information to the memory device with the coil.

29. The method as recited in claim 28, including writing information indicative of use of the key.

30. The method as recited in claim 29, wherein said step of writing information to the memory device occurs prior to enabling movement of the locking member from the locked position to an unlocked position.
